(19) United States
(12) Patent Application Publication
(10) Pub. No.: US 2022/0127546 A1
(43) Pub. Date: Apr. 28, 2022

(54) METHODS OF MAKING GLYCERIDE OLIGOMERS AND PRODUCTS FORMED THEREFROM

(71) Applicant: ELEVANCE RENEWABLE SCIENCES, INC., Woodridge, IL (US)

(72) Inventors: Karunakaran Narasimhan, Woodridge, IL (US); Alyssa Catherine Hotalen, Woodridge, IL (US); Neil Thomas Fairweather, Woodridge, IL (US); Luke Andrew Zannoni, Woodridge, IL (US); Beth Annn Schubert, Woodridge, IL (US); Andrea Dannenberg, Woodridge, IL (US); Steven A. Cohen, Woodridge, IL (US)

(21) Appl. No.: 17/429,750

(22) PCT Filed: Feb. 19, 2020
(86) PCT No.: PCT/US2020/018746

§ 371 Date: Aug. 10, 2021

Related U.S. Application Data
(60) Provisional application No. 62/808,340, filed on Feb. 21, 2019.

(51) Int. Cl. C11C 3/06; C08G 63/06; B01J 31/22

(52) U.S. Cl. CPC C11C 3/06; B01J 2531/821; B01J 31/2278; C08G 63/06

(57) ABSTRACT

Improved processes for making glyceride oligomers are generally disclosed herein. In some embodiments, the disclosed processes provide improved methods of using olefin metathesis to oligomerize unsaturated glycerides to make novel branched-chain polyester compositions. In some aspects, the disclosure also provides compositions formed by such processes.

### CROSS REFERENCE TO THE RELATED APPLICATION

This application claims priority to U.S. Provisional Application No. 62/808,340, filed on Feb. 21, 2019. The entire content of said provisional application is herein incorporated by reference for all purposes.

### TECHNICAL FIELD

Improved processes for making glyceride oligomers are generally disclosed herein. In some embodiments, the disclosed processes provide improved methods of using olefin metathesis to oligomerize unsaturated glycerides to make novel branched-chain polyester compositions. In some aspects, the disclosure also provides compositions formed by such processes.

### BACKGROUND

Branched-chain polyesters have a wide variety of applications. Their high molecular weight and low crystallinity makes them attractive for use in adhesive compositions, personal and consumer care compositions, as plasticizers and rheology modifiers, and the like. Such compounds are typically derived from certain short-chain dicarboxylic acids, such as adipic acid. Thus, such compounds may be unsuitable for certain applications, especially where it may be desirable that the polyester contain longer-chain hydrophobic portions.

The self-metathesis of natural oils (unsaturated fatty acid glycerides), such as soybean oil, provides one means of making branched-chain polyesters having longer-chain hydrophobic portions. Certain such methods are disclosed in U.S. Patent Application Publication No. 2013/0344012. But, using such methods, it is still difficult to obtain branched-chain polyester compositions having a higher molecular weight, such as molecular weights corresponding to oligomers containing, on average, about 5-6 triglycerides or more. Obtaining higher molecular-weight oligomers using such methods presents a number of difficulties, including practical limits on the time and the quality of the vacuum needed to remove the product olefins to drive the reaction toward making higher-molecular-weight oligomers.

Thus, while using self-metathesis of unsaturated fatty acid glycerides provides a useful means of obtaining branched-chain polyesters, there remains a continuing need to develop further processes that would allow for the practical synthesis of higher-weight glyceride oligomers.

### SUMMARY

The present disclosure overcomes one or more of the above hurdles by providing higher molecular-weight glyceride oligomers and processes for making such compounds and compositions.

In a first aspect, the disclosure provides methods of forming a glyceride polymer, the methods comprising: (a) providing a reaction mixture comprising unsaturated natural oil glycerides; (b) introducing a first quantity of an olefin metathesis catalyst to the reaction mixture to react the unsaturated natural oil glycerides and form a first product mixture comprising unreacted unsaturated natural oil glycerides, first oligomerized unsaturated natural oil glycerides, and a first olefin byproduct; and (c) introducing a second quantity of the olefin metathesis catalyst to the first product mixture to react the unreacted unsaturated natural oil glycerides and the first oligomerized unsaturated natural oil glycerides and form a second product mixture comprising second oligomerized unsaturated natural oil glycerides and a second olefin byproduct.

In a second aspect, the disclosure provides methods of forming a glyceride polymer, the methods comprising: (a) providing a reaction mixture comprising unsaturated natural oil glycerides, and, optionally, initial oligomerized unsaturated natural oil glycerides; (b) introducing a first quantity of an olefin metathesis catalyst to the reaction mixture to react the unsaturated natural oil glycerides and, optionally, the initial oligomerized unsaturated natural oil glycerides, and form a first product mixture comprising unreacted unsaturated natural oil glycerides, first oligomerized unsaturated natural oil glycerides, and a first olefin byproduct; and (c) introducing a second quantity of the olefin metathesis catalyst to the first product mixture to react the unreacted unsaturated natural oil glycerides and the first oligomerized unsaturated natural oil glycerides and form a second product mixture comprising second oligomerized unsaturated natural oil glycerides and a second olefin byproduct; wherein the method comprises isomerizing the first oligomerized unsaturated natural oil glycerides.

In a third aspect, the disclosure provides glyceride polymers formed by the methods of the first aspect, or any embodiments thereof.

In a fourth aspect, the disclosure provides glyceride polymers formed by the methods of the second aspect, or any embodiments thereof.

Further aspects and embodiments are provided in the foregoing drawings, detailed description and claims.

### BRIEF DESCRIPTION OF THE DRAWINGS

The following drawings are provided for purposes of illustrating various embodiments of the compositions and methods disclosed herein. The drawings are provided for illustrative purposes only, and are not intended to describe any preferred compositions or preferred methods, or to serve as a source of any limitations on the scope of the claimed inventions.

FIG. 1 shows a non-limiting embodiment of a method disclosed herein for forming a glyceride polymer.

FIG. 2 shows a non-limiting embodiment of a method disclosed herein for forming a glyceride polymer.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure, and are not meant to be limiting in any fashion. Nor do these phrases indicate any kind of preference for the disclosed embodiment.

As used herein, “polymer” refers to a substance having a chemical structure that includes the multiple repetition of constitutional units formed from substances of comparatively low relative molecular mass relative to the molecular mass of the polymer. The term “polymer” includes soluble and/or fusible molecules having chains of repeat units, and also includes insoluble and infusible networks. As used herein, the term “polymer” can include oligomeric materials, which have only a few (e.g., 3-100) constitutional units

As used herein, “natural oil” refers to oils obtained from plants or animal sources. The terms also include modified plant or animal sources (e.g., genetically modified plant or animal sources), unless indicated otherwise. Examples of natural oils include, but are not limited to, vegetable oils, algae oils, fish oils, animal fats, tall oils, derivatives of these oils, combinations of any of these oils, and the like. Representative non-limiting examples of vegetable oils include rapeseed oil (canola oil), coconut oil, corn oil, cottonseed oil, olive oil, palm oil, peanut oil, safflower oil, sesame oil, soybean oil, sunflower oil, linseed oil, palm kernel oil, tung oil, jatropha oil, mustard seed oil, pennycress oil, camelina oil, hempseed oil, and castor oil. Representative non-limiting examples of animal fats include lard, tallow, poultry fat, yellow grease, and fish oil. Tall oils are by-products of wood pulp manufacture. In some embodiments, the natural oil or natural oil feedstock comprises one or more unsaturated glycerides (e.g., unsaturated triglycerides). In some such embodiments, the natural oil comprises at least 50% by weight, or at least 60% by weight, or at least 70% by weight, or at least 80% by weight, or at least 90% by weight, or at least 95% by weight, or at least 97% by weight, or at least 99% by weight of one or more unsaturated triglycerides, based on the total weight of the natural oil.

The term “natural oil glyceride” refers to a glyceryl ester of a fatty acid obtained from a natural oil. Such glycerides include monoacylglycerides, diacylglycerides, and triacylglyceriedes (triglycerides). In some embodiments, the natural oil glycerides are triglycerides. Analogously, the term “unsaturated natural oil glyceride” refers to natural oil glycerides, wherein at least one of its fatty acid residues contains unsaturation. For example, a glyceride of oleic acid is an unsaturated natural oil glyceride. The term “unsaturated alkenylized natural oil glyceride” refers to an unsaturated natural oil glyceride (as defined above) that is derivatized via a metathesis reaction with a short-chain olefin (as defined below). In some cases, olefinizing process shortens one or more of the fatty acid chains in the compound. For example, a glyceride of 9-decenoic acid is an unsaturated alkenylized natural oil glyceride. Similarly, butenylized (e.g., with 1-butene and/or 2-butene) canola oil is a natural oil glyceride that has been modified via metathesis to contain some short-chain unsaturated C₁₀-C₁₅ ester groups.

The term “oligomeric glyceride moiety” is a moiety comprising two or more (and up to 10, or up to 20) constitutional units formed via olefin metathesis from natural oil glycerides and/or alkenylized natural oil glycerides.

As used herein, “metathesis” refers to olefin metathesis. As used herein, “metathesis catalyst” includes any catalyst or catalyst system that catalyzes an olefin metathesis reaction.

As used herein, “metathesize” or “metathesizing” refer to the reacting of a feedstock in the presence of a metathesis catalyst to form a “metathesized product” comprising new olefinic compounds, i.e., “metathesized” compounds. Metathesizing is not limited to any particular type of olefin metathesis, and may refer to cross-metathesis (i.e., co-metathesis), self-metathesis, ring-opening metathesis, ring-opening metathesis polymerizations (“ROMP”), ring-closing metathesis (“RCM”), and acyclic diene metathesis (“ADMET”). In some embodiments, metathesizing refers to reacting two triglycerides present in a natural feedstock (self-metathesis) in the presence of a metathesis catalyst, wherein each triglyceride has an unsaturated carbon-carbon double bond, thereby forming a new mixture of olefins and esters which may include a triglyceride dimer. Such triglyceride dimers may have more than one olefinic bond, thus higher oligomers also may form. Additionally, in some other embodiments, metathesizing may refer to reacting an olefin, such as ethylene, and a triglyceride in a natural feedstock having at least one unsaturated carbon-carbon double bond, thereby forming new olefinic molecules as well as new ester molecules (cross-metathesis).

As used herein, “olefin” or “olefins” refer to compounds having at least one unsaturated carbon-carbon double bond. In certain embodiments, the term “olefins” refers to a group of unsaturated carbon-carbon double bond compounds with different carbon lengths. Unless noted otherwise, the terms “olefin” or “olefins” encompasses “polyunsaturated olefins” or “poly-olefins,” which have more than one carbon-carbon double bond. As used herein, the term “monounsaturated olefins” or “mono-olefins” refers to compounds having only one carbon-carbon double bond. A compound having a terminal carbon-carbon double bond can be referred to as a “terminal olefin” or an “alpha-olefin,” while an olefin having a non-terminal carbon-carbon double bond can be referred to as an “internal olefin.” In some embodiments, the alpha-olefin is a terminal alkene, which is an alkene (as defined below) having a terminal carbon-carbon double bond. Additional carbon-carbon double bonds can be present.

The number of carbon atoms in any group or compound can be represented by the terms: “C_{z}”, which refers to a group of compound having z carbon atoms; and “C_{x-y}”, which refers to a group or compound containing from x to y, inclusive, carbon atoms. For example, “C₁₋₆ alkyl” represents an alkyl chain having from 1 to 6 carbon atoms and, for example, includes, but is not limited to, methyl, ethyl, n-propyl, isopropyl, isobutyl, n-butyl, sec-butyl, tert-butyl, isopentyl, n-pentyl, neopentyl, and n-hexyl. As a further example, a “C₄₋₁₀ alkene” refers to an alkene molecule having from 4 to 10 carbon atoms, and, for example, includes, but is not limited to, 1-butene, 2-butene, isobutene, 1-pentene, 1-hexene, 3-hexene, 1-heptene, 3-heptene, 1-octene, 4-octene, 1-nonene, 4-nonene, and 1-decene.

As used herein, the terms “short-chain alkene” or “short-chain olefin” refer to any one or combination of unsaturated straight, branched, or cyclic hydrocarbons in the C₂₋₁₄ range, or the C₂₋₁₂ range, or the C₂₋₁₀ range, or the C₂₋₈ range. Such olefins include alpha-olefins, wherein the unsaturated carbon-carbon bond is present at one end of the compound. Such olefins also include dienes or trienes. Such olefins also include internal olefins. Examples of short-chain alkenes in the C₂₋₆ range include, but are not limited to: ethylene, propylene, 1-butene, 2-butene, isobutene, 1-pentene, 2-pentene, 2-methyl-1-butene, 2-methyl-2-butene, 3-methyl-1-butene, cyclopentene, 1,4-pentadiene, 1-hexene, 2-hexene, 3-hexene, 2-methyl-1-pentene, 3-methyl-1-pentene, 4-methyl-1-pentene, 2-methyl-2-pentene, 3-methyl-2-pentene, 4-methyl-2-pentene, 2-methyl-3-pentene, and cyclohexene. Non-limiting examples of short-chain alkenes in the C₇₋₉ range include 1,4-heptadiene, 1-heptene, 3,6-nonadiene, 3-nonene, 1,4,7-octatriene. In certain embodiments, it is preferable to use a mixture of olefins, the mixture comprising linear and branched low-molecular-weight olefins in the C₄₋₁₀ range. In one embodiments, it may be preferable to use a mixture of linear and branched C₄ olefins (i.e., combinations of: 1-butene, 2-butene, and/or isobutene). In other embodiments, a higher range of C₁₁₋₁₄ may be used.

As used herein, “alkyl” refers to a straight or branched chain saturated hydrocarbon having 1 to 30 carbon atoms, which may be optionally substituted, as herein further described, with multiple degrees of substitution being allowed. Examples of “alkyl,” as used herein, include, but are not limited to, methyl, ethyl, n-propyl, isopropyl, isobutyl, n-butyl, sec-butyl, tert-butyl, isopentyl, n-pentyl, neopentyl, n-hexyl, and 2-ethylhexyl. The number of carbon atoms in an alkyl group is represented by the phrase “C_{x-y} alkyl,” which refers to an alkyl group, as herein defined, containing from x to y, inclusive, carbon atoms. Thus, “C₁₋₆ alkyl” represents an alkyl chain having from 1 to 6 carbon atoms and, for example, includes, but is not limited to, methyl, ethyl, n-propyl, isopropyl, isobutyl, n-butyl, sec-butyl, tert-butyl, isopentyl, n-pentyl, neopentyl, and n-hexyl. In some instances, the “alkyl” group can be divalent, in which case the group can alternatively be referred to as an “alkylene” group.

As used herein, “alkenyl” refers to a straight or branched chain non-aromatic hydrocarbon having 2 to 30 carbon atoms and having one or more carbon-carbon double bonds, which may be optionally substituted, as herein further described, with multiple degrees of substitution being allowed. Examples of “alkenyl,” as used herein, include, but are not limited to, ethenyl, 2-propenyl, 2-butenyl, and 3-butenyl. The number of carbon atoms in an alkenyl group is represented by the phrase “C_{x-y} alkenyl,” which refers to an alkenyl group, as herein defined, containing from x to y, inclusive, carbon atoms. Thus, “C₂₋₆ alkenyl” represents an alkenyl chain having from 2 to 6 carbon atoms and, for example, includes, but is not limited to, ethenyl, 2-propenyl, 2-butenyl, and 3-butenyl. In some instances, the “alkenyl” group can be divalent, in which case the group can alternatively be referred to as an “alkenylene” group.

As used herein, “mix” or “mixed” or “mixture” refers broadly to any combining of two or more compositions. The two or more compositions need not have the same physical state; thus, solids can be “mixed” with liquids, e.g., to form a slurry, suspension, or solution. Further, these terms do not require any degree of homogeneity or uniformity of composition. This, such “mixtures” can be homogeneous or heterogeneous, or can be uniform or non-uniform. Further, the terms do not require the use of any particular equipment to carry out the mixing, such as an industrial mixer.

As used herein, “optionally” means that the subsequently described event(s) may or may not occur. In some embodiments, the optional event does not occur. In some other embodiments, the optional event does occur one or more times.

As used herein, “comprise” or “comprises” or “comprising” or “comprised of” refer to groups that are open, meaning that the group can include additional members in addition to those expressly recited. For example, the phrase, “comprises A” means that A must be present, but that other members can be present too. The terms “include,” “have,” and “composed of” and their grammatical variants have the same meaning. In contrast, “consist of” or “consists of” or “consisting of” refer to groups that are closed. For example, the phrase “consists of A” means that A and only A is present.

As used herein, “or” is to be given its broadest reasonable interpretation, and is not to be limited to an either/or construction. Thus, the phrase “comprising A or B” means that A can be present and not B, or that B is present and not A, or that A and B are both present. Further, if A, for example, defines a class that can have multiple members, e.g., A₁ and A₂, then one or more members of the class can be present concurrently.

Other terms are defined in other portions of this description, even though not included in this subsection.

### Methods Involving Batched Catalyst Introduction

In at least one aspect, the disclosure provides methods of forming a glyceride polymer, the methods comprising: (a) providing a reaction mixture comprising unsaturated natural oil glycerides; (b) introducing a first quantity of an olefin metathesis catalyst to the reaction mixture to react the unsaturated natural oil glycerides and form a first product mixture comprising unreacted unsaturated natural oil glycerides, first oligomerized unsaturated natural oil glycerides, and a first olefin byproduct; and (c) introducing a second quantity of the olefin metathesis catalyst to the first product mixture to react the unreacted unsaturated natural oil glycerides and the first oligomerized unsaturated natural oil glycerides and form a second product mixture comprising second oligomerized unsaturated natural oil glycerides and a second olefin byproduct.

A feature of such methods is the introduction of the olefin metathesis catalyst in two or more batches. Thus, in some embodiments, additional batches of olefin metathesis catalyst can be added. For example, in some embodiments, the second product mixture further comprises unreacted unsaturated natural oil glycerides, and further comprising introducing a third quantity of the olefin metathesis catalyst to the second product mixture to react the unreacted unsaturated natural oil glycerides and the second oligomerized unsaturated natural oil glycerides and form a third product mixture comprising third oligomerized unsaturated natural oil glycerides and a third olefin byproduct.

In the same way, a fourth batch of catalyst can be added. Thus, in some further embodiments, the third product mixture further comprises unreacted unsaturated natural oil glycerides, and further comprising introducing a fourth quantity of the olefin metathesis catalyst to the third product mixture to react the unreacted unsaturated natural oil glycerides and the third oligomerized unsaturated natural oil glycerides and form a fourth product mixture comprising fourth oligomerized unsaturated natural oil glycerides and a fourth olefin byproduct.

In the same way, a fifth batch of catalyst can be added. Thus, in some further embodiments, the fourth product mixture further comprises unreacted unsaturated natural oil glycerides, and further comprising introducing a fifth quantity of the olefin metathesis catalyst to the fourth product mixture to react the unreacted unsaturated natural oil glycerides and the fourth oligomerized unsaturated natural oil glycerides and form a fifth product mixture comprising fifth oligomerized unsaturated natural oil glycerides and a fifth olefin byproduct.

In the embodiments set forth in the preceding paragraphs, the amount of olefin metathesis catalyst can vary (or be the same) from one batch to the next. Thus, in some embodiments of the preceding embodiments, the weight-to-weight ratio of any two of the first quantity of the olefin metathesis catalyst, the second quantity of the olefin metathesis catalyst, the third quantity of the olefin metathesis catalyst, the fourth quantity of the olefin metathesis catalyst, and the fifth quantity of the olefin metathesis catalyst, ranges from 1:10 to 10:1, or from 1:5 to 5:1, or from 1:3 to 3:1, or from 1:2 to 2:1.

In general, the unsaturated natural oil glycerides are derived from one or more natural oils. In some further embodiments, the unsaturated natural oil glycerides are derived from one or more vegetable oils, such as seed oils. Any suitable vegetable oil can be used, including, but not limited to, rapeseed oil, canola oil (low erucic acid rapeseed oil), coconut oil, corn oil, cottonseed oil, olive oil, palm oil, peanut oil, safflower oil, sesame oil, soybean oil, sunflower oil, linseed oil, palm kernel oil, tung oil, jatropha oil, mustard seed oil, pennycress oil, camelina oil, hempseed oil, castor oil, or any combination thereof. In some embodiments, the vegetable oil is canola oil.

Such seed vegetable oils fatty acid glycerides, where at least one of the hydroxyl groups on glycerin forms an ester with an unsaturated fatty acid. Such glycerides can be monoglycerides, diglycerides, triglycerides, or any combination thereof. The unsaturated fatty acid moiety can be one that occurs in nature (e.g., oleic acid), or, in some other examples, it can one that is formed from alkenylizing an unsaturated fatty acid (e.g., 9-decenoic acid, which can be formed by reacting an alpha-olefin with a naturally occurring fatty acid, such as oleic acid). Thus, in some embodiments, the unsaturated natural oil glycerides comprise glycerides of unsaturated fatty acids selected from the group consisting of: oleic acid, linoleic acid, linolenic acid, vaccenic acid, 9-decenoic acid, 9-undecenoic acid, 9-dodecenoic acid, 9,12-tridecadienoic acid, 9,12-tetradecadienoic acid, 9,12-pentadecadienoic acid, 9,12,15-hexadecatrienoic acid, 9,12,15 heptadecatrienoic acid, 9,12,15-octadecatrienoic acid, 11-dodecenoic acid, 11-tridecenoic acid, and 11-tetradecenoic acid.

As noted above, the unsaturated natural oil glycerides can, in some embodiments, include unsaturated alkenylized natural oil glycerides. The unsaturated alkenylized natural oil glyceride is formed from the reaction of a second unsaturated natural oil glyceride with a short-chain alkene in the presence of a second metathesis catalyst. In some such embodiments, the unsaturated alkenylized natural oil glyceride has a lower molecular weight than the second unsaturated natural oil glyceride. Any suitable short-chain alkene can be used, according to the embodiments described above. In some embodiments, the short-chain alkene is a C₂₋₈ olefin, or a C₂₋₆ olefin. In some such embodiments, the short-chain alkene is ethylene, propylene, 1-butene, 2-butene, isobutene, 1-pentene, 2-pentene, 1-hexene, 2-hexene, or 3-hexene. In some further such embodiments, the short-chain alkene is ethylene, propylene, 1-butene, 2-butene, or isobutene. In some embodiments, the short-chain alkene is ethylene. In some embodiments, the short-chain alkene is propylene. In some embodiments, the short-chain alkene is 1-butene. In some embodiments, the short-chain alkene is 2-butene.

In embodiments where the unsaturated natural oil glycerides include unsaturated alkenylized natural oil glycerides, the unsaturated alkenylized natural oil glycerides can make up any suitable amount of the composition. In some embodiments, the unsaturated natural oil glycerides include at least 5 weight percent, or at least 10 weight percent, or at least 15 weight percent, or at least 20 weight percent, or at least 25 weight percent, each up to 50 weight percent, or 60 weight percent, or 70 weight percent, based on the total weight of the unsaturated natural oil glycerides in the composition.

Any suitable olefin metathesis catalyst can be used. In some embodiments, the olefin metathesis catalyst comprises an organoruthenium compound, an organoosmium compound, an organotungsten compound, an organomolybdenum compound, or any combination thereof. In some embodiments, the olefin metathesis catalyst comprises an organoruthenium compound.

Any suitable molecular weight can be achieved at each stage of the process. For example, in some embodiments, the second oligomerized unsaturated natural oil glycerides a molecular weight (M_{w}) ranging from 4,000 g/mol to 150,000 g/mol, or from 5,000 g/mol to 130,000 g/mol, or from 6,000 g/mol to 100,000 g/mol, or from 7,000 g/mol to 50,000 g/mol, or from 8,000 g/mol to 30,000 g/mol, or from 9,000 g/mol to 20,000 g/mol. In some such embodiments, the second oligomerized unsaturated natural oil glycerides have a higher molecular weight (M_{w}) than the first oligomerized unsaturated natural oil glycerides.

In some further embodiments, the third oligomerized unsaturated natural oil glycerides a molecular weight (M_{w}) ranging from 4,000 g/mol to 150,000 g/mol, or from 5,000 g/mol to 130,000 g/mol, or from 6,000 g/mol to 100,000 g/mol, or from 7,000 g/mol to 50,000 g/mol, or from 8,000 g/mol to 30,000 g/mol, or from 9,000 g/mol to 20,000 g/mol. In some such embodiments, the third oligomerized unsaturated natural oil glycerides have a higher molecular weight (M_{w}) than the second oligomerized unsaturated natural oil glycerides.

In some further embodiments, the fourth oligomerized unsaturated natural oil glycerides a molecular weight (M_{w}) ranging from 4,000 g/mol to 150,000 g/mol, or from 5,000 g/mol to 130,000 g/mol, or from 6,000 g/mol to 100,000 g/mol, or from 7,000 g/mol to 50,000 g/mol, or from 8,000 g/mol to 30,000 g/mol, or from 9,000 g/mol to 20,000 g/mol. In some such embodiments, the fourth oligomerized unsaturated natural oil glycerides have a higher molecular weight (M_{w}) than the third oligomerized unsaturated natural oil glycerides.

In some further embodiments, the fifth oligomerized unsaturated natural oil glycerides a molecular weight (M_{w}) ranging from 4,000 g/mol to 150,000 g/mol, or from 5,000 g/mol to 130,000 g/mol, or from 6,000 g/mol to 100,000 g/mol, or from 7,000 g/mol to 50,000 g/mol, or from 8,000 g/mol to 30,000 g/mol, or from 9,000 g/mol to 20,000 g/mol. In some such embodiments, the fifth oligomerized unsaturated natural oil glycerides have a higher molecular weight (M_{w}) than the fourth oligomerized unsaturated natural oil glycerides.

As noted above, the oligomerization process yields an olefin byproduct. In some instances, it may be desirable to remove at least a portion of this byproduct, for example, to drive the reaction to completion, to mitigate the risk of unwanted side reactions, and the like. Thus, in some embodiments of any of the aforementioned embodiments, one or more of the additional steps can be incorporated: removing at least a portion of the first olefin byproduct from the first product mixture, removing at least a portion of the second olefin byproduct from the second product mixture, removing at least a portion of the third olefin byproduct from the third product mixture, removing at least a portion of the fourth olefin byproduct from the fourth product mixture, and removing at least a portion of the fifth olefin byproduct from the fifth product mixture.

The removing can be carried out by any suitable means, such as venting the reactor, stripping procedures, etc. Various means of removing olefin byproducts are set forth in U.S. Patent Application Publication No. 2013/0344012, which disclosure is hereby incorporated by reference.

The olefin metathesis reactions can be carried out at any suitable temperature. In some embodiments, the olefin metathesis reactions that generate the first product mixture, the second product mixture, the third product mixture, the fourth product mixture, or the fifth product mixture, are carried out at a temperature of no more than 150° C., or no more than 140° C., or no more than 130° C., or no more than 120° C., or no more than 110° C., or no more than 100° C. In some such embodiments, the temperature of the reactor is maintained from one batch to the next. In some other instances, however, the reactor may be cooled to a lower temperature (e.g., room temperature) between steps.

The methods disclosed herein can include additional chemical and physical treatment of the resulting glyceride copolymers. For example, in some embodiments, the resulting glyceride copolymers are subjected to full or partial hydrogenation, such as diene-selective hydrogenation.

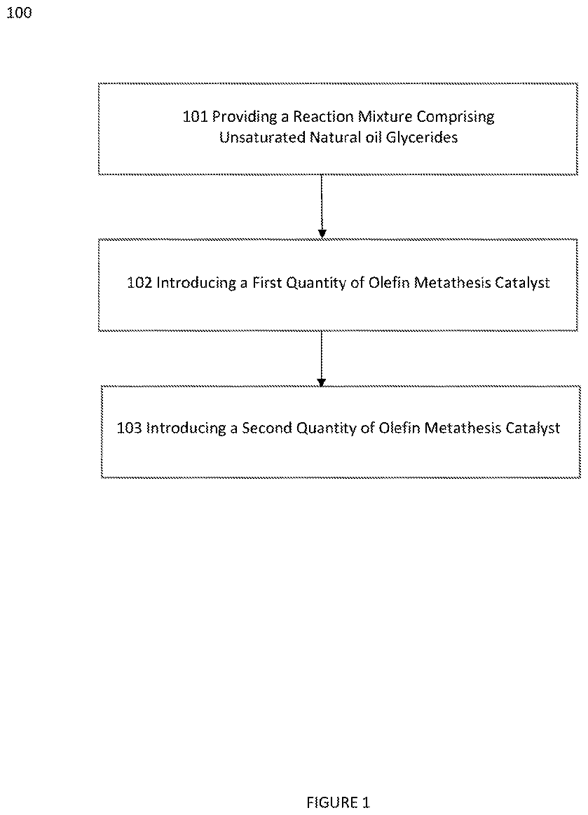

FIG. 1 discloses a non-limiting embodiment of a method of forming a glyceride polymer 100, comprising: providing a reaction mixture comprising unsaturated natural oil glycerides 101; introducing a first quantity of an olefin metathesis catalyst to the reaction mixture to react the unsaturated natural oil glycerides and form a first product mixture comprising unreacted unsaturated natural oil glycerides, first oligomerized unsaturated natural oil glycerides, and a first olefin byproduct 102; and introducing a second quantity of the olefin metathesis catalyst to the first product mixture to react the unreacted unsaturated natural oil glycerides and the first oligomerized unsaturated natural oil glycerides and form a second product mixture comprising second oligomerized unsaturated natural oil glycerides and a second olefin byproduct 103.

### Processes Involving Isomerization

In at least one aspect, any one or more of the first oligomerized unsaturated natural oil glycerides, second oligomerized unsaturated natural oil glycerides, third oligomerized unsaturated natural oil glycerides, or fourth oligomerized unsaturated natural oil glycerides.

The isomerizing can be carried out by any suitable means for isomerizing the olefinic bonds in unsaturated products. Suitable methods are set forth in U.S. Pat. No. 9,382,502, which is hereby incorporated by reference.

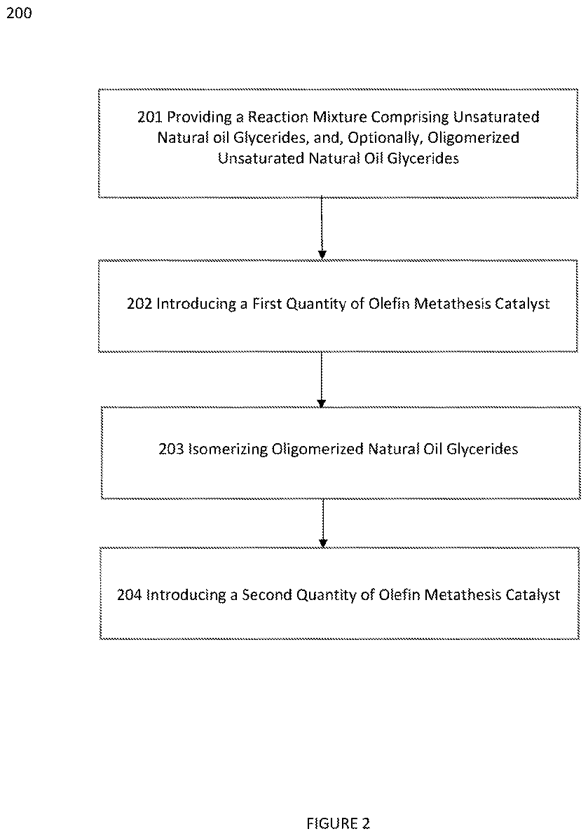

FIG. 2 discloses a non-limiting embodiment of a method of forming a glyceride polymer 200, comprising: providing a reaction mixture comprising unsaturated natural oil glycerides, and, optionally, initial oligomerized unsaturated natural oil glycerides 201; introducing a first quantity of an olefin metathesis catalyst to the reaction mixture to react the unsaturated natural oil glycerides and, optionally, the initial oligomerized unsaturated natural oil glycerides, and form a first product mixture comprising unreacted unsaturated natural oil glycerides, first oligomerized unsaturated natural oil glycerides, and a first olefin byproduct 202; isomerizing the first oligomerized unsaturated natural oil glycerides 203; and introducing a second quantity of the olefin metathesis catalyst to the first product mixture to react the unreacted unsaturated natural oil glycerides and the first (isomerized) oligomerized unsaturated natural oil glycerides and form a second product mixture comprising second oligomerized unsaturated natural oil glycerides and a second olefin byproduct 204.

Derivation from Renewable Sources

The compounds employed in any of the aspects or embodiments disclosed herein can, in certain embodiments, be derived from renewable sources, such as from various natural oils or their derivatives. Any suitable methods can be used to make these compounds from such renewable sources.

Olefin metathesis provides one possible means to convert certain natural oil feedstocks into olefins and esters that can be used in a variety of applications, or that can be further modified chemically and used in a variety of applications. In some embodiments, a composition (or components of a composition) may be formed from a renewable feedstock, such as a renewable feedstock formed through metathesis reactions of natural oils and/or their fatty acid or fatty ester derivatives. When compounds containing a carbon-carbon double bond undergo metathesis reactions in the presence of a metathesis catalyst, some or all of the original carbon-carbon double bonds are broken, and new carbon-carbon double bonds are formed. The products of such metathesis reactions include carbon-carbon double bonds in different locations, which can provide unsaturated organic compounds having useful chemical properties.

A wide range of natural oils, or derivatives thereof, can be used in such metathesis reactions. Examples of suitable natural oils include, but are not limited to, vegetable oils, algae oils, fish oils, animal fats, tall oils, derivatives of these oils, combinations of any of these oils, and the like. Representative non-limiting examples of vegetable oils include rapeseed oil (canola oil), coconut oil, corn oil, cottonseed oil, olive oil, palm oil, peanut oil, safflower oil, sesame oil, soybean oil, sunflower oil, linseed oil, palm kernel oil, tung oil, jatropha oil, mustard seed oil, pennycress oil, camelina oil, hempseed oil, and castor oil. Representative non-limiting examples of animal fats include lard, tallow, poultry fat, yellow grease, and fish oil. Tall oils are by-products of wood pulp manufacture. In some embodiments, the natural oil or natural oil feedstock comprises one or more unsaturated glycerides (e.g., unsaturated triglycerides). In some such embodiments, the natural oil feedstock comprises at least 50% by weight, or at least 60% by weight, or at least 70% by weight, or at least 80% by weight, or at least 90% by weight, or at least 95% by weight, or at least 97% by weight, or at least 99% by weight of one or more unsaturated triglycerides, based on the total weight of the natural oil feedstock.

The natural oil may include canola or soybean oil, such as refined, bleached and deodorized soybean oil (i.e., RBD soybean oil). Soybean oil typically includes about 95 percent by weight (wt %) or greater (e.g., 99 wt % or greater) triglycerides of fatty acids. Major fatty acids in the polyol esters of soybean oil include but are not limited to saturated fatty acids such as palmitic acid (hexadecanoic acid) and stearic acid (octadecanoic acid), and unsaturated fatty acids such as oleic acid (9-octadecenoic acid), linoleic acid (9,12-octadecadienoic acid), and linolenic acid (9,12,15-octadecatrienoic acid).

Such natural oils, or derivatives thereof, contain esters, such as triglycerides, of various unsaturated fatty acids. The identity and concentration of such fatty acids varies depending on the oil source, and, in some cases, on the variety. In some embodiments, the natural oil comprises one or more esters of oleic acid, linoleic acid, linolenic acid, or any combination thereof. When such fatty acid esters are metathesized, new compounds are formed. For example, in embodiments where the metathesis uses certain short-chain alkenes, e.g., ethylene, propylene, or 1-butene, and where the natural oil includes esters of oleic acid, an amount of 1-decene and 1-decenoid acid (or an ester thereof), among other products, are formed.

In some embodiments, the natural oil can be subjected to various pre-treatment processes, which can facilitate their utility for use in certain metathesis reactions. Useful pre-treatment methods are described in United States Patent Application Publication Nos. 2011/0113679, 2014/0275595, and 2014/0275681, all three of which are hereby incorporated by reference as though fully set forth herein.

In some embodiments, after any optional pre-treatment of the natural oil feedstock, the natural oil feedstock is reacted in the presence of a metathesis catalyst in a metathesis reactor. In some other embodiments, an unsaturated ester (e.g., an unsaturated glyceride, such as an unsaturated triglyceride) is reacted in the presence of a metathesis catalyst in a metathesis reactor. These unsaturated esters may be a component of a natural oil feedstock, or may be derived from other sources, e.g., from esters generated in earlier-performed metathesis reactions.

The conditions for such metathesis reactions, and the reactor design, and suitable catalysts are as described below with reference to the metathesis of the olefin esters. That discussion is incorporated by reference as though fully set forth herein.

### Olefin Metathesis

In some embodiments, one or more of the unsaturated monomers can be made by metathesizing a natural oil or natural oil derivative. The terms “metathesis” or “metathesizing” can refer to a variety of different reactions, including, but not limited to, cross-metathesis, self-metathesis, ring-opening metathesis, ring-opening metathesis polymerizations (“ROMP”), ring-closing metathesis (“RCM”), and acyclic diene metathesis (“ADMET”). Any suitable metathesis reaction can be used, depending on the desired product or product mixture.

In some embodiments, after any optional pre-treatment of the natural oil feedstock, the natural oil feedstock is reacted in the presence of a metathesis catalyst in a metathesis reactor. In some other embodiments, an unsaturated ester (e.g., an unsaturated glyceride, such as an unsaturated triglyceride) is reacted in the presence of a metathesis catalyst in a metathesis reactor. These unsaturated esters may be a component of a natural oil feedstock, or may be derived from other sources, e.g., from esters generated in earlier-performed metathesis reactions. In certain embodiments, in the presence of a metathesis catalyst, the natural oil or unsaturated ester can undergo a self-metathesis reaction with itself.

In some embodiments, the metathesis comprises reacting a natural oil feedstock (or another unsaturated ester) in the presence of a metathesis catalyst. In some such embodiments, the metathesis comprises reacting one or more unsaturated glycerides (e.g., unsaturated triglycerides) in the natural oil feedstock in the presence of a metathesis catalyst. In some embodiments, the unsaturated glyceride comprises one or more esters of oleic acid, linoleic acid, linoleic acid, or combinations thereof. In some other embodiments, the unsaturated glyceride is the product of the partial hydrogenation and/or the metathesis of another unsaturated glyceride (as described above).

The metathesis process can be conducted under any conditions adequate to produce the desired metathesis products. For example, stoichiometry, atmosphere, solvent, temperature, and pressure can be selected by one skilled in the art to produce a desired product and to minimize undesirable byproducts. In some embodiments, the metathesis process may be conducted under an inert atmosphere. Similarly, in embodiments where a reagent is supplied as a gas, an inert gaseous diluent can be used in the gas stream. In such embodiments, the inert atmosphere or inert gaseous diluent typically is an inert gas, meaning that the gas does not interact with the metathesis catalyst to impede catalysis to a substantial degree. For example, non-limiting examples of inert gases include helium, neon, argon, methane, and nitrogen, used individually or with each other and other inert gases.

The reactor design for the metathesis reaction can vary depending on a variety of factors, including, but not limited to, the scale of the reaction, the reaction conditions (heat, pressure, etc.), the identity of the catalyst, the identity of the materials being reacted in the reactor, and the nature of the feedstock being employed. Suitable reactors can be designed by those of skill in the art, depending on the relevant factors, and incorporated into a refining process such, such as those disclosed herein.

The metathesis reactions disclosed herein generally occur in the presence of one or more metathesis catalysts. Such methods can employ any suitable metathesis catalyst. The metathesis catalyst in this reaction may include any catalyst or catalyst system that catalyzes a metathesis reaction. Any known metathesis catalyst may be used, alone or in combination with one or more additional catalysts. Examples of metathesis catalysts and process conditions are described in US 2011/0160472, incorporated by reference herein in its entirety, except that in the event of any inconsistent disclosure or definition from the present specification, the disclosure or definition herein shall be deemed to prevail. A number of the metathesis catalysts described in US 2011/0160472 are presently available from Materia, Inc. (Pasadena, Calif.).

In some embodiments, the metathesis catalyst includes a Grubbs-type olefin metathesis catalyst and/or an entity derived therefrom. In some embodiments, the metathesis catalyst includes a first-generation Grubbs-type olefin metathesis catalyst and/or an entity derived therefrom. In some embodiments, the metathesis catalyst includes a second-generation Grubbs-type olefin metathesis catalyst and/or an entity derived therefrom. In some embodiments, the metathesis catalyst includes a first-generation Hoveyda-Grubbs-type olefin metathesis catalyst and/or an entity derived therefrom. In some embodiments, the metathesis catalyst includes a second-generation Hoveyda-Grubbs-type olefin metathesis catalyst and/or an entity derived therefrom. In some embodiments, the metathesis catalyst includes one or a plurality of the ruthenium carbene metathesis catalysts sold by Materia, Inc. of Pasadena, Calif. and/or one or more entities derived from such catalysts. Representative metathesis catalysts from Materia, Inc. for use in accordance with the present teachings include but are not limited to those sold under the following product numbers as well as combinations thereof: product no. C823 (CAS no. 172222-30-9), product no. C848 (CAS no. 246047-72-3), product no. C601 (CAS no. 203714-71-0), product no. C627 (CAS no. 301224-40-8), product no. C571 (CAS no. 927429-61-6), product no. C598 (CAS no. 802912-44-3), product no. C793 (CAS no. 92742960-5), product no. C801 (CAS no. 194659-03-9), product no. C827 (CAS no. 253688-91-4), product no. C884 (CAS no. 900169-53-1), product no. C833 (CAS no. 1020085-61-3), product no. C859 (CAS no. 832146-68-6), product no. C711 (CAS no. 635679-24-2), product no. C933 (CAS no. 373640-75-6).

In some embodiments, the metathesis catalyst includes a molybdenum and/or tungsten carbene complex and/or an entity derived from such a complex. In some embodiments, the metathesis catalyst includes a Schrock-type olefin metathesis catalyst and/or an entity derived therefrom. In some embodiments, the metathesis catalyst includes a high-oxidation-state alkylidene complex of molybdenum and/or an entity derived therefrom. In some embodiments, the metathesis catalyst includes a high-oxidation-state alkylidene complex of tungsten and/or an entity derived therefrom. In some embodiments, the metathesis catalyst includes molybdenum (VI). In some embodiments, the metathesis catalyst includes tungsten (VI). In some embodiments, the metathesis catalyst includes a molybdenum- and/or a tungsten-containing alkylidene complex of a type described in one or more of (a) Angew. Chem. Int. Ed. Engl., 2003, 42, 4592-4633; (b) Chem. Rev., 2002, 102, 145-179; and/or (c) Chem. Rev., 2009, 109, 3211-3226, each of which is incorporated by reference herein in its entirety, except that in the event of any inconsistent disclosure or definition from the present specification, the disclosure or definition herein shall be deemed to prevail.

In certain embodiments, the metathesis catalyst is dissolved in a solvent prior to conducting the metathesis reaction. In certain such embodiments, the solvent chosen may be selected to be substantially inert with respect to the metathesis catalyst. For example, substantially inert solvents include, without limitation: aromatic hydrocarbons, such as benzene, toluene, xylenes, etc.; halogenated aromatic hydrocarbons, such as chlorobenzene and dichlorobenzene; aliphatic solvents, including pentane, hexane, heptane, cyclohexane, etc.; and chlorinated alkanes, such as dichloromethane, chloroform, dichloroethane, etc. In some embodiments, the solvent comprises toluene.

In other embodiments, the metathesis catalyst is not dissolved in a solvent prior to conducting the metathesis reaction. The catalyst, instead, for example, can be slurried with the natural oil or unsaturated ester, where the natural oil or unsaturated ester is in a liquid state. Under these conditions, it is possible to eliminate the solvent (e.g., toluene) from the process and eliminate downstream olefin losses when separating the solvent. In other embodiments, the metathesis catalyst may be added in solid state form (and not slurried) to the natural oil or unsaturated ester (e.g., as an auger feed).

The metathesis reaction temperature may, in some instances, be a rate-controlling variable where the temperature is selected to provide a desired product at an acceptable rate. In certain embodiments, the metathesis reaction temperature is greater than −40° C., or greater than −20° C., or greater than 0° C., or greater than 10° C. In certain embodiments, the metathesis reaction temperature is less than 200° C., or less than 150° C., or less than 120° C. In some embodiments, the metathesis reaction temperature is between 0° C. and 150° C., or is between 10° C. and 120° C.

### EXAMPLES

The following examples show certain illustrative embodiments of the compounds, compositions, and methods disclosed herein. These examples are not to be taken as limiting in any way. Nor should the examples be taken as expressing any preferred embodiments, or as indicating any direction for further research. Unless otherwise noted, chemicals used were ACS, reagent, or the standard grade available from Sigma-Aldrich.

The examples below report the determination of molecular weight by gel permeation chromatography (GPC) for certain compositions containing glyceride copolymers. Weight-average molecular weight (M_{w}) values were determined using HPLC analysis of the resulting samples using a polystyrene calibration curve. In general, chloroform was used as the mobile phase.

Table 1 shows the molecular weights and the retention times of the polystyrene standards.

TABLE 1

| Standard Number | Average | Retention |
|---|---|---|
| (min) | Reported MW | Time |
| 1 | 150,000 | 19.11 |
| 2 | 100,000 | 19.63 |
| 3 | 70,000 | 20.43 |
| 4 | 50,000 | 20.79 |
| 5 | 30,000 | 21.76 |
| 6 | 9,000 | 23.27 |
| 7 | 5,000 | 23.86 |
| 8 | 1,000 | 27.20 |
| 9 | 500 | 28.48 |

### Example A1—Batch Process with Overnight Hold and No THMP

Self-metathesized polyoil was prepared by charging canola oil (23 kg) to a 30 liter glass reactor. The canola oil was pre-treated by sparging with nitrogen while heating to 200° C. for a hold time of 2 hours. The canola oil was cooled to room temperature and stirred with nitrogen sparge overnight. The pre-treated canola oil was then heated to 95° C. under nitrogen sparge followed by the addition of a toluene solution of C827 metathesis catalyst (20 ppm catalyst relative to weight of oil) and stirring for 1 hour. An additional toluene solution of C827 metathesis catalyst (20 ppm catalyst relative to weight of oil-40 ppm total catalyst) was added followed by stirring for 1 hour. An additional toluene solution of C827 metathesis catalyst (10 ppm catalyst relative to weight of oil-50 ppm total catalyst) was added with stirring for 1 hour. The molecular weight after 5 hours (50 ppm catalyst) of the reaction was 11,013. The reaction was kept overnight at 95° C. under nitrogen sparge. The next morning an additional toluene solution of C827 metathesis catalyst (10 ppm catalyst relative to weight of oil-60 ppm total) was added followed by stirring for 1 hour. A 3.5 kg sample of polyoil with no THMP added was then taken. The reaction was cooled and discharged. Further details are set forth in Table 2 below.

### Example A2—Batch Process with Overnight Hold and THMP

The process of Example A1 was carried out as set forth above, except that before the final discharge, the reaction mixture was cooled to 80° C. followed by addition of THMP (5 molar equivalents relative to the total catalyst added less the catalyst removed with the 3.5 kg sample) and stirring for 2 hours. Further details are set forth in Table 2 below.

### Example A3—Batch Process with Overnight Hold and No THMP

The process of Example 1 was carried out as set forth above, except that the addition of THMP was not performed. The reaction was performed under nitrogen blanket. One hour after 50 ppm total catalyst was added an additional toluene solution of C827 metathesis catalyst (10 ppm catalyst relative to weight of oil-60 ppm total catalyst) was added. The molecular weight after 6 hours (60 ppm catalyst) of reaction was 10,912 Da. The reaction was left overnight at 95° C. under nitrogen blanket. The next morning an additional toluene solution of C827 metathesis catalyst (10 ppm catalyst relative to weight of oil-70 ppm total) was added followed by stirring for 1 hour. A 2.0 kg sample of polyoil with no THMP added was then taken. The reaction mixture was cooled to 80° C. and stirring for 2 hours. The reaction was cooled and discharged. Further details are set forth in Table 2 below.

### Example A4—Batch Process with Overnight Hold and THMP

The process of Example A3 was carried out as set forth above, except that before the final discharge, the reaction mixture was cooled to 80° C. followed by addition of THMP (5 molar equivalents relative to the total catalyst added less the catalyst removed with the 3.5 kg sample) and stirring for 2 hours. Further details are set forth in Table 2 below.

### Example A5—Batch Process with Overnight Hold and No THMP

Toluene solutions of C827 metathesis catalyst were added in doses of 20 ppm/20 ppm/10 ppm (relative to weight of oil) every 30 minutes. After one hour of stirring an additional toluene solution of C827 metathesis catalyst (10 ppm catalyst relative to weight of oil-60 ppm total catalyst) was added. The molecular weight after 8 hours (60 ppm catalyst) of reaction was 11,106. The reaction was left overnight at 95° C. with nitrogen sparge. The next morning an additional toluene solution of C827 metathesis catalyst (10 ppm catalyst relative to weight of oil-70 ppm total) was added followed by stirring for 1 hour. The reaction was cooled and discharged. The yield was 0.77 kg polyoil/kg canola oil (after handling losses).

TABLE 2

| | | Total | | THMP | Final |
|---|---|---|---|---|---|
| Ex- | Reactor | catalyst | WFE | added | polyoil |
| ample | size | (ppm) | (Y/N) | (Y/N) | Mw |
| A1 | 30 liter | 60 ppm | Y | N | 11,909 |
| A2 | 30 liter | 60 ppm | Y | Y | 11,705 |
| A3 | 30 liter | 70 ppm | Y | N | 11,307 |
| A4 | 30 liter | 70 ppm | Y | Y | 11,404 |
| AS | 30 liter | 70 ppm | Y | N | 12,032 |

### Example B1—Batch Process with Heating/Cooling

Self-metathesized polyoil was prepared by charging canola oil to a 2 L liter glass reactor. The canola oil was pre-treated by sparging with nitrogen while heating to 200° C. for a hold time of 2 hours. The canola oil was cooled to room temperature and stirred with nitrogen sparge overnight. The pre-treated canola oil was then heated to 95° C. followed by the addition of a toluene solution of C827 metathesis catalyst (25 ppm catalyst relative to weight of oil). Vacuum was applied to 20 Torr with stirring for 1 hour. Vacuum was broken with an additional toluene solution of C827 metathesis catalyst (25 ppm catalyst relative to weight of oil-50 ppm total catalyst) followed by stirring under vacuum for 1 hour. The temperature of the reaction was raised to 180° C. with stirring for 1 hour. The reaction was cooled to 95° C. under vacuum followed by the addition of a toluene solution of C827 metathesis catalyst (25 ppm catalyst relative to weight of oil-75 ppm total catalyst) and stirring for 1 hour followed by the addition of a toluene solution of C827 metathesis catalyst (25 ppm catalyst relative to weight of oil-100 ppm total catalyst) and stirring for 1 hour. The reaction was kept under a nitrogen sparge while cooling to room temperature overnight. The reaction mixture was warmed to 85° C. followed by addition of THMP (5 molar equivalents relative to the total catalyst added) and stirring for 2 hours. The reaction mixture was cooled and discharged into buckets. Further information is set forth in Table 3.

### Example B2—Batch Process with Heating/Cooling

The process of Example B1 was carried out as set forth above, except that catalyst was added dropwise by addition funnel, targeting ˜25 ppm/hour for a total of 100 ppm catalyst. Further information is set forth in Table 3.

### Example B3—Batch Process with Heating/Cooling

The process of Example B1 was carried out as set forth above, except that experiment performed in 2 L kettle flask instead of 2 L round bottom. Further information is set forth in Table 3.

### Example B4—Batch Process with Heating/Cooling

Self-metathesized polyoil was prepared by charging canola oil (7500 g) to a 10 liter glass reactor. The canola oil was pre-treated by sparging with nitrogen while heating to 200° C. for a hold time of 2 hours. The canola oil was cooled to room temperature and stirred with nitrogen sparge overnight. The pre-treated canola oil was then heated to 95° C. followed by the addition of a toluene solution of C827 metathesis catalyst (25 ppm catalyst relative to weight of oil). Vacuum was applied to 20 Torr with stirring for 1 hour. Vacuum was broken with an additional toluene solution of C827 metathesis catalyst (25 ppm catalyst relative to weight of oil-50 ppm total catalyst) followed by stirring under vacuum for 1 hour. The temperature of the reaction was raised to 180° C. with stirring for 1 hour. The reaction was cooled to 95° C. under vacuum followed by the addition of a toluene solution of C827 metathesis catalyst (25 ppm catalyst relative to weight of oil-75 ppm total catalyst) and stirring for 1 hour followed by the addition of a toluene solution of C827 metathesis catalyst (25 ppm catalyst relative to weight of oil-100 ppm total catalyst) and stirring for 1 hour. The reaction was kept under a nitrogen sparge while cooling to room temperature overnight. The reaction mixture was warmed to 85° C. followed by addition of THMP (5 molar equivalents relative to the total catalyst added) and stirring for 2 hours. The reaction mixture was cooled and discharged into buckets.

TABLE 3

| Ex- | Reactor | Target | Total catalyst | Final |
|---|---|---|---|---|
| ample | size | Vacuum | (ppm) | polyoil Mw |
| B1 | 2 liter | 20 Torr | 100 ppm | 15,650 |
| B2 | 2 liter | 20 Torr | 100 ppm | 16,166 |
| B3 | 2 liter | 20 Torr | 100 ppm | 13,188 |
| C4 | 10 liter | 20 Torr | 100 ppm | 12,978 |

### Example B6—Batch Process with Overnight Hold and THMP

Self-metathesized polyoil was prepared by charging canola oil (1000 g) to a 2 liter glass reactor. The canola oil was then heated to 95° C. followed by the addition of a toluene solution of C827 metathesis catalyst (25 ppm catalyst relative to weight of oil). Vacuum was applied to 20 Torr with stirring for 1 hour. Vacuum was broken with an additional toluene solution of C827 metathesis catalyst (25 ppm catalyst relative to weight of oil-50 ppm total catalyst) followed by stirring under vacuum for 1 hour. The temperature of the reaction was raised to 180° C. with stirring for 1 hour. The reaction was cooled to 95° C. under vacuum followed by the addition of a toluene solution of C827 metathesis catalyst (25 ppm catalyst relative to weight of oil-75 ppm total catalyst) and stirring for 1 hour followed by the addition of a toluene solution of C827 metathesis catalyst (25 ppm catalyst relative to weight of oil-100 ppm total catalyst) and stirring for 1 hour. The reaction was kept under a nitrogen sparge at 95° C. overnight. The reaction mixture was cooled to 80° C. followed by addition of THMP (25 molar equivalents relative to the total catalyst added) and stirring for 2 hours. The reaction mixture was cooled and discharged. Further information is set forth in Table 4.

### Example B7—Batch Process with Heating/Cooling

The process of Example B6 was carried out as set forth above, except that a N2 sparge instead of vacuum was used for the first 75 ppm catalyst addition. A vacuum of 20 Torr was used while the temperature was increased to 180° C. and for the last addition of 25 ppm of catalyst (total catalyst addition of 100 ppm). Further information is set forth in Table 4.

### Example B8—Batch Process with Heating/Cooling

The process of Example B6 was carried out as set forth above, except that the experiment was performed in a 2 L kettle flask and an additional 25 ppm catalyst was added (total catalyst of 125 ppm) followed by stirring for 1 hour. Further information is set forth in Table 4.

### Example B9—Batch Process with Heating/Cooling

The process of Example B6 was carried out as set forth above, except that the experiment was performed in a 2 L kettle flask and the temperature was raised to 200° C. instead of 180° C. followed by stirring for 1 hour. Further information is set forth in Table 4. Table 4

TABLE 4

| Ex- | Reactor | Target | Total catalyst | Final |
|---|---|---|---|---|
| ample | size | Vacuum | (ppm) | polyoil Mw |
| B6 | 2 liter | 20 Torr | 100 ppm | 12,978 |
| B7 | 2 liter | N2 sparge/20 Torr | 100 ppm | 11,554 |
| B8 | 2 liter | 20 Torr | 125 ppm | 11,488 |
| B9 | 2 liter | 20 Torr | 100 ppm | 11,958 |

### Example C1—Batch Process with No Overnight Hold

Self-metathesized polyoil was prepared by charging canola oil (1000 g) to a 2 liter glass reactor. The canola oil was then heated to 95° C. under a stream of nitrogen followed by the addition of a toluene solution of C827 metathesis catalyst (25 ppm catalyst relative to weight of oil) and stirring for 1 hour. Catalyst was added in 1 hour increments (25 ppm) for a total of 100 ppm catalyst added. The reaction was cooled and discharged. Further details are provided in Table 5.

### Example C2—Batch Process with No Overnight Hold

The process of Example C1 was carried out as set forth above, except that catalyst added 25 ppm at 30 minute intervals rather than 1 hour. Further information is set forth in Table 5.

TABLE 5

| Ex- | Reactor | Total catalyst | WFE | THMP added | Final |
|---|---|---|---|---|---|
| ample | size | (ppm) | (Y/N) | (Y/N) | polyoil Mw |
| C1 | 2 liter | 100 ppm | N | N | 11,405 |
| C2 | 2 liter | 100 ppm | N | N | 10,929 |

### Example C3—Batch Process with Overnight Hold

Self-metathesized polyoil was prepared by charging canola oil (500 g) to a 1 liter glass reactor. The canola oil was then heated to 95° C. under a stream of nitrogen followed by the addition of a toluene solution of C827 metathesis catalyst (25 ppm catalyst relative to weight of oil) and stirring for 1 hour. An additional toluene solution of C827 metathesis catalyst (25 ppm catalyst relative to weight of oil-50 ppm total catalyst) was added followed by stirring under nitrogen at 95° C. overnight. An additional toluene solution of C827 metathesis catalyst (25 ppm catalyst relative to weight of oil-75 ppm total catalyst) was added with stirring for 1 hour followed by the addition of a toluene solution of C827 metathesis catalyst (25 ppm catalyst relative to weight of oil-100 ppm total catalyst) and stirring for 1 hour (total reaction time ˜24 hours). The reaction was cooled and discharged. Further information is set forth in Table 6.

### Example C4—Batch Process with No Overnight Hold

The process of Example C1 was carried out as set forth above. Further information is set forth in Table 6.

TABLE 6

| Ex- | Reactor | Total catalyst | WFE | THMP added | Final |
|---|---|---|---|---|---|
| ample | size | (ppm) | (Y/N) | (Y/N) | polyoil Mw |
| C3 | 2 liter | 100 ppm | N | N | 16,262 |
| C4 | 2 liter | 100 ppm | N | N | 16,263 |

### Example D—Olefin Stripping

Crude polyoil was charged to the WFE feed flask and processed at a temperature set point of 180° C., 200° C., 230° C., or 245° C. at full vacuum (Welch belt drive pump) to separate the reaction olefins from the desired polyoil. Product polyoil was evaluated for residual odor.

1. A method of forming a glyceride polymer, the method comprising:
(a) providing a reaction mixture comprising unsaturated natural oil glycerides;
(b) introducing a first quantity of an olefin metathesis catalyst to the reaction mixture to react the unsaturated natural oil glycerides and form a first product mixture comprising unreacted unsaturated natural oil glycerides, first oligomerized unsaturated natural oil glycerides, and a first olefin byproduct; and
(c) introducing a second quantity of the olefin metathesis catalyst to the first product mixture to react the unreacted unsaturated natural oil glycerides and the first oligomerized unsaturated natural oil glycerides and form a second product mixture comprising second oligomerized unsaturated natural oil glycerides and a second olefin byproduct.

2. The method of claim 1, wherein second product mixture further comprises unreacted unsaturated natural oil glycerides, and further comprising introducing a third quantity of the olefin metathesis catalyst to the second product mixture to react the unreacted unsaturated natural oil glycerides and the second oligomerized unsaturated natural oil glycerides and form a third product mixture comprising third oligomerized unsaturated natural oil glycerides and a third olefin byproduct.

3. The method of claim 2, wherein third product mixture further comprises unreacted unsaturated natural oil glycerides, and further comprising introducing a fourth quantity of the olefin metathesis catalyst to the third product mixture to react the unreacted unsaturated natural oil glycerides and the third oligomerized unsaturated natural oil glycerides and form a fourth product mixture comprising fourth oligomerized unsaturated natural oil glycerides and a fourth olefin byproduct.

4. The method of claim 3, wherein fourth product mixture further comprises unreacted unsaturated natural oil glycerides, and further comprising introducing a fifth quantity of the olefin metathesis catalyst to the fourth product mixture to react the unreacted unsaturated natural oil glycerides and the fourth oligomerized unsaturated natural oil glycerides and form a fifth product mixture comprising fifth oligomerized unsaturated natural oil glycerides and a fifth olefin byproduct.

5. The method of claim 4, wherein a weight-to-weight ratio of any two of the first quantity of the olefin metathesis catalyst, the second quantity of the olefin metathesis catalyst, the third quantity of the olefin metathesis catalyst, the fourth quantity of the olefin metathesis catalyst, and the fifth quantity of the olefin metathesis catalyst, ranges from 1:10 to 10:1.

6. The method of claim 1, wherein the unsaturated natural oil glycerides comprise glycerides of unsaturated fatty acids selected from the group consisting of: oleic acid, linoleic acid, linolenic acid, vaccenic acid, 9-decenoic acid, 9-undecenoic acid, 9-dodecenoic acid, 9,12-tridecadienoic acid, 9,12-tetradecadienoic acid, 9,12-pentadecadienoic acid, 9,12,15-hexadecatrienoic acid, 9,12,15 heptadecatrienoic acid, 9,12,15-octadecatrienoic acid, 11-dodecenoic acid, 11-tridecenoic acid, and 11-tetradecenoic acid.

7. The method of claim 1, wherein the olefin metathesis catalyst comprises an organoruthenium compound, an organoosmium compound, an organotungsten compound, an organomolybdenum compound, or any combination thereof.

8. The method of claim 1, wherein the unsaturated natural oil glycerides are derived from a natural oil.

9. The method of claim 8, wherein the unsaturated natural oil glycerides are derived from a vegetable oil.

10. The method of claim 9, wherein the vegetable oil is rapeseed oil, canola oil (low erucic acid rapeseed oil), coconut oil, corn oil, cottonseed oil, olive oil, palm oil, peanut oil, safflower oil, sesame oil, soybean oil, sunflower oil, linseed oil, palm kernel oil, tung oil, jatropha oil, mustard seed oil, pennycress oil, camelina oil, hempseed oil, castor oil, or any combination thereof.

11. The method of claim 1, wherein the second oligomerized unsaturated natural oil glycerides a molecular weight (M_{w}) ranging from 4,000 g/mol to 150,000 g/mol.

12. The method of claim 11, wherein the second oligomerized unsaturated natural oil glycerides have a higher molecular weight (M_{w}) than the first oligomerized unsaturated natural oil glycerides.

13. The method of claim 2, wherein the third oligomerized unsaturated natural oil glycerides a molecular weight (M_{w}) ranging from 4,000 g/mol to 150,000 g/mol.

14. The method of claim 13, wherein the third oligomerized unsaturated natural oil glycerides have a higher molecular weight (M_{w}) than the second oligomerized unsaturated natural oil glycerides.

15. The method of claim 3, wherein the fourth oligomerized unsaturated natural oil glycerides a molecular weight (M_{w}) ranging from 4,000 g/mol to 150,000 g/mol.

16. The method of claim 15, wherein the fourth oligomerized unsaturated natural oil glycerides have a higher molecular weight (M_{w}) than the third oligomerized unsaturated natural oil glycerides.

17. The method of claim 4, wherein the fifth oligomerized unsaturated natural oil glycerides a molecular weight (M_{w}) ranging from 4,000 g/mol to 150,000 g/mol.

18. The method of claim 17, wherein the fifth oligomerized unsaturated natural oil glycerides have a higher molecular weight (M_{w}) than the fourth oligomerized unsaturated natural oil glycerides.

19. The method of claim 18, further comprising one or more of: removing at least a portion of the first olefin byproduct from the first product mixture, removing at least a portion of the second olefin byproduct from the second product mixture, removing at least a portion of the third olefin byproduct from the third product mixture, removing at least a portion of the fourth olefin byproduct from the fourth product mixture, and removing at least a portion of the fifth olefin byproduct from the fifth product mixture.

20. The method of claim 19, wherein the olefin metathesis reactions that generate the first product mixture, the second product mixture, the third product mixture, the fourth product mixture, or the fifth product mixture, are carried out at a temperature of no more than 150° C.

21-43. (canceled)
